(19) United States
(12) Patent Application Publication
(10) Pub. No.: US 2026/0215366 A1
(43) Pub. Date: Jul. 30, 2026

(54) SYSTEMS AND METHODS FOR GRAIN LOSS DETECTION AND ANALYSIS

(71) Applicant: Deere & Company, Moline, IL (US)

(72) Inventors: Federico Pardina-Malbran, Fort Collins, CO (US); Nathan R. Vandike, Geneseo, IL (US)

(21) Appl. No.: 19/040,257

(22) Filed: Jan. 29, 2025

(51) Int. Cl. A01D 41/127; A01F 12/44

(52) U.S. Cl. CPC A01D 41/1273; A01D 41/1276; A01F 12/448

(57) ABSTRACT

A residue detection system is provided for analyzing chaffer material collected from a flow of a crop material residue along a chaffer of a cleaning shoe of an agricultural machine. The system can include a gate that, when open, accommodates a flow of chaffer material into a trough that can contain another crop material residue. An optical device can capture information of the chaffer material within the trough that can be used to determine a property of the chaffer material. The system can determine whether captured information includes chaffer material in different ways, including based on a time delay between the opening of the gate and obtaining the captured information. The chaffer material property can also be determined based on an amount residue detected within a field of view of the optical device. The determined property can be used to update functions and operations that seek to minimize grain loss.

### FIELD OF THE DISCLOSURE

The present disclosure generally relates to grain loss detection and, more specifically, to systems and methods for analyzing one or more residue properties of residue located above a chaffer of a cleaning shoe in connection with improving the accuracy of grain loss detection.

### BACKGROUND

Agricultural machines can include agricultural and construction vehicles and equipment, as well as combinations thereof, that are used to perform different agricultural and industrial tasks. For example, one or more agricultural machines, including, but not limited to, harvesters and windrowers, can be utilized to plant crops, harvest crops, bale or otherwise collect crops, and spray or distribute crop inputs, such as, for example, fertilizer or chemicals, over a field or plants within a field.

### SUMMARY

The present disclosure can comprise one or more of the following features and combinations thereof.

In one embodiment of the present disclosure, a residue detection system is provided for analysis of a chaffer material collected from a flow of a first crop material residue along a chaffer of a cleaning shoe of an agricultural machine. The residue detection system can include a gate that can be selectively displaceable between an open position and a closed position and an imaging system that can include an optical device. The residue detection system can further include a material flow pathway that can be configured to receive at least a second crop material residue. Additionally, the residue detection system can include at least one processor and a memory coupled with the at least one processor. The memory can include instructions that when executed by the at least one processor cause the at least one processor to generate a signal to facilitate a displacement of the gate from the closed position to the open position, the gate being positioned to, when in the open position, provide an opening for the chaffer material to be delivered to the material flow pathway. Further, memory can include instructions that when executed by the at least one processor cause the at least one processor to generate a signal to activate the optical device to obtain a captured information of the chaffer material, and determine, using at least the captured information, a residue property of the chaffer material.

In another one embodiment of the present disclosure, a residue detection system is provided for analysis of a chaffer material collected from a flow of a crop material residue along a chaffer of a cleaning shoe of an agricultural machine. The residue detection system can include a gate selectively displaceable between an open position and a closed position, and a tailings system that can have a tailings trough, a first sensor, a tailings elevator, and an optical system. The tailing trough can receive a grain tailings, and the gate can be positioned to, when the gate is in the open position, provide a passageway for a delivery of the chaffer material to the tailing trough. Additionally, the tailings elevator can be configured to convey at least a portion of the chaffer material to a location at which the portion of the chaffer material is within a field of view of an optical device of the optical system. The residue detection system can also include at least one processor and a memory coupled with the at least one processor. The memory can include instructions that when executed by the at least one processor cause the at least one processor to generate a signal to activate the optical device to capture a captured information of at least the portion of the chaffer material that is within the field of view of the optical device, and determine, using at least the captured information, a residue property of at least the portion of the chaffer material.

According to another embodiment, a method is provided for analyzing a composition of a chaffer material collected from a flow of a first crop material residue along a chaffer of a cleaning shoe of an agricultural machine. The method can include displacing a gate from a closed position to an open position and delivering, in response to the gate being displaced to the open position, the chaffer material through the gate and into a material flow pathway. The method can also include determining, from the captured information, a residue property of the chaffer material.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements can be exaggerated relative to other elements for clarity. Further, where considered appropriate, reference labels have been repeated among the figures to indicate corresponding or analogous elements.

FIG. 1 illustrates a partial cutaway side view of an exemplary agricultural machine in the form of a harvester.

FIG. 2 illustrates a near side, fragmentary, perspective view of an exemplary crop cleaning system taken from the agricultural machine shown in FIG. 1.

FIG. 3 illustrates a perspective side view of a portion of an exemplary cleaning shoe.

FIG. 4 illustrates a perspective side view of a simplified representation of a portion of a cleaning shoe.

FIG. 5 illustrates a perspective view of an exemplary grain tailings elevator.

FIG. 6 illustrates a simplified partial cross-sectional view of a portion of the grain tailings elevator shown in FIG. 5.

FIG. 7 is a simplified block diagram representation of an exemplary residue detection system.

FIG. 8 illustrates a perspective side view of a portion of an exemplary cleaning shoe with a gate for a residue detection system in a closed position.

FIG. 9 illustrates a perspective side view of a portion of an exemplary cleaning shoe in which the residue detection system has a plurality of gates.

FIG. 10A illustrates an exemplary residue housing for a residue detection system having a gate and a base door that are each in a closed position.

FIG. 10B illustrates the residue housing shown in FIG. 10A in which the gate is in an open position and a quantity of chaffer material has accumulated on the closed base door.

FIG. 10C illustrates the residue housing shown in FIG. 10A in which the gate and base door are both in open positions.

FIG. 11 illustrates a simplified flow diagram of an exemplary method for using a residue detection system to detect residue properties associated with grain.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described can include a particular feature, structure, or characteristic, but every embodiment can or cannot necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features can be shown in specific arrangements or orderings. However, it should be appreciated that such specific arrangements and orderings are not required in every instance. Rather, in some embodiments, such features can be arranged in a different manner or order than shown in the illustrative figures. Additionally, the inclusion of a structural or method feature in a particular figure is not meant to imply that such feature is required in all embodiments and, in some embodiments, can be excluded or combined with other features.

At least certain types of agricultural machines are configured to process cut crop material in a manner that can separate a harvested crop, such as, for example, grain, from other portions of the cut crop material, which can generally be referred to as material other than grain (MOG), including, for example, chaff. For example, certain types of agricultural machines, such as combines, can be configured to separate a harvested crop (e.g., grain) from chaff, among other MOG, with the MOG being subsequently chopped by a chopper of the agricultural machine before being dispensed from the agricultural machine, including being dispensed onto a field. In certain situations, at least a portion of grain that is not separated from the MOG can be dispensed with the chopped MOG onto the field, thereby resulting in crop loss, also generally referred to herein as grain loss.

Such grain loss can be tracked or estimated in a variety of manners. For example, certain types of agricultural machines can use strike sensors, including piezoelectric sensing elements, among others, in generating estimates as to the extent of such grain loss. Moreover, such sensors can be positioned downstream of a flow of MOG and configured to detect when grain, such as, for example, a seed, within the flow of MOG hits or strikes the sensor(s). The number of hits or strikes of the grain against the sensor(s), including, for example, a number of strikes within a predetermined time period, can be correlated, such as, for example, via a transfer function, to an amount of MOG dispensed from the agricultural machine to determine the grain loss.

Accurate detection of the quantity of grain contained in MOG that is being dispensed onto the field can be useful in determining which, if any, remedial actions are to be taken to minimize the grain loss. However, the accuracy of grain loss detection, including accurate detection of grain strikes against a strike sensor, can be influenced by a variety of factors. For example, the quantity, size, or moisture content of either or both the MOG and the grain, as well as various combinations thereof, among other factors, can impact the detection, including proper recognition, of strikes against a strike sensor that are to be attributed to grain. Additionally, accurate detection, including recognition, of a strike against the strike sensor can be adversely impacted by chaff or other MOG interfering with grain directly striking the strike sensor. For example, in certain instances, the presence of chaff can dampen a strike of grain against a strike sensor, thereby preventing accurate detection of a strike of the sensor by the grain. Alternatively, a collection of chaff can have a size that, when the chaff hits the strike sensor, the force of the strike can be incorrectly detected, including interpreted, as being a grain strike. Further, the quantity of chaff can adversely impact the ability of grain to come into contact with a strike sensor, thereby also interfering with the accuracy of the information used to determine grain loss. An inaccurate indication of grain loss can adversely impact at least the corrective actions implemented to reduce the grain loss.

Embodiments of the subject application address challenges with respect to accurate detection of grain loss by providing a system and method for accurately quantifying one or more residue properties with respect to at least residue flowing over a chaffer. Such residue properties can include, for example, one or more of: a grain, among other types of harvested crop, to chaff ratio; an amount of grain or free grain within at least a sampling(s) or captured image(s) of the residue; grain properties (e.g., either or both grain volume or weight); one or more chaff or chaffer properties, such as, for example, size, type, amount (e.g., either or both volume and weight), or moisture content; and combined grain and chaffer properties, such as, for example, either or both combined volume and weight, as well as various combinations thereof, among other properties. According to certain embodiments, an imaging system is utilized to analyze residue material, also referred to herein as chaffer material, that is selectively collected from above or along the chaffer. Such embodiments can improve efficiency in separating grain from chaff in the cleaning shoe, and moreover, reduce grain loss. Moreover, embodiments discussed herein can determine a grain to chaff signal that can provide information to improve transfer functions and machine settings, including with respect to either or both an operation of a cleaning system and settings of the agricultural machine.

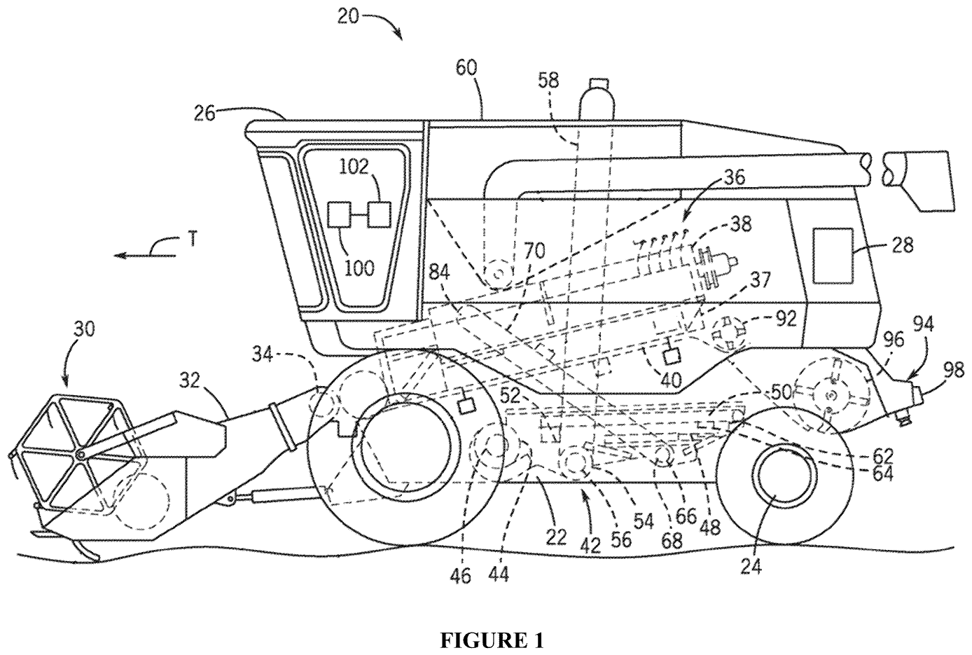

FIG. 1 illustrates a partial cutaway side view of an exemplary agricultural machine 20 in the form of a harvester. The agricultural machine 20 includes a chassis 22 and one or more ground engaging mechanisms, such as wheels 24 or tracks, which are in contact with an underlying ground surface. In the illustrative embodiment, the wheels 24 are coupled to the chassis 22 and are used, in connection with a prime mover 28, such as, for example, an engine, for propulsion of the agricultural machine 20 in a forward operating direction (“T”) and in other directions. In some embodiments, operation of the agricultural machine 20 is controlled from an operator cab 26. The operator cab 26 can include any number of controls for controlling the operation of the agricultural machine 20, such as a user interface. In some embodiments, operation of the agricultural machine 20 can be conducted by a human operator in the operator cab 26, a remote human operator, or an automated system. Thus, according to certain embodiments, the agricultural machine 20 can be an autonomous or semi-autonomous vehicle. Moreover, according to certain embodiments, the agricultural machine 20 can be, or be operated, as an unmanned vehicle. Thus, according to certain embodiments, the agricultural machine 20 may not include an operator cab 26.

A user interface system 100 can be positioned at the operator cab 26, or at another location at, or away from, the agricultural machine 20. The user interface system 100 can include either or both input devices and output devices, as well as a combination thereof, that an operator of the agricultural machine 20 can use to control and manipulate the agricultural machine 20. Such input and output devices can include one or more display devices, touch screens, audio devices, haptic devices, levers, joysticks, steering wheels, pedals, or buttons, as well as various combinations thereof, among other devices.

A header 30 can be mounted at the front of the agricultural machine 20 to cut and gather crop material from a field. The header 30 is supported by a feederhouse 32, which is pivotally mounted to the chassis 22. The feederhouse 32 can include, for example, an inclined conveyor (not shown) for transport of cut crop material from the header 30 into the body of the agricultural machine 20. After passing over a guide drum or feed accelerator 34, the crop material from the feederhouse 32 reaches a generally fore-aft oriented threshing device or separator 36. Other embodiments can include laterally oriented or other threshing devices (not shown). In the embodiment depicted, the separator 36 includes one or more rotors 38, on which various threshing elements are mounted. The rotor 38 rotates above one or more grated or sieved threshing baskets or concaves 40, such that crop material passing between the rotor 38 and the concave 40 is separated, at least in part, into grain and chaff (or other “material other than grain” (MOG)). The MOG is carried rearward and released from between the rotor 38 and the concave 40. Most of the grain (and some of the MOG) separated in the separator 36 falls downward through apertures in the concave 40. A separator loss sensor 37 senses grain loss in the separator 36 as separate grain-loss signals or a combined or aggregate signal.

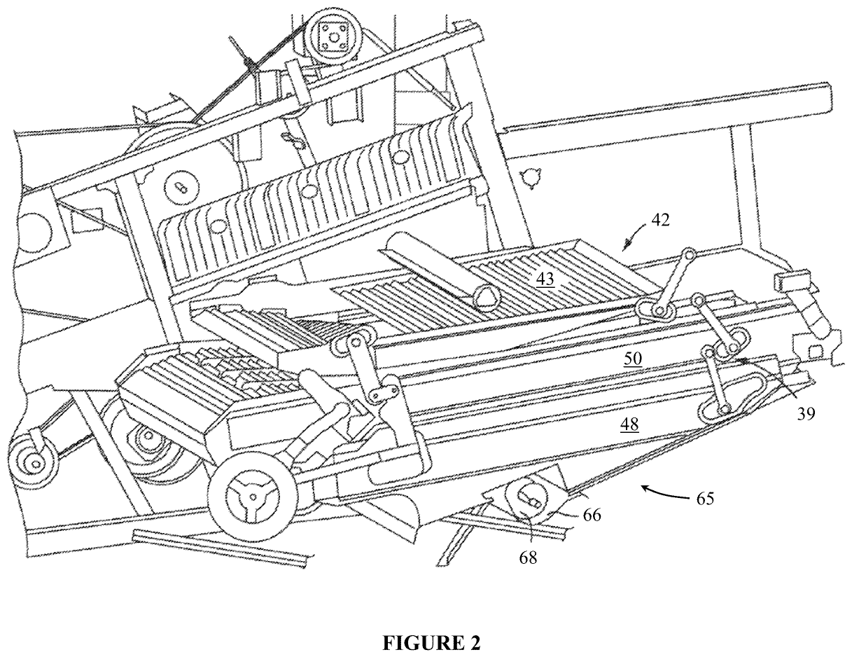

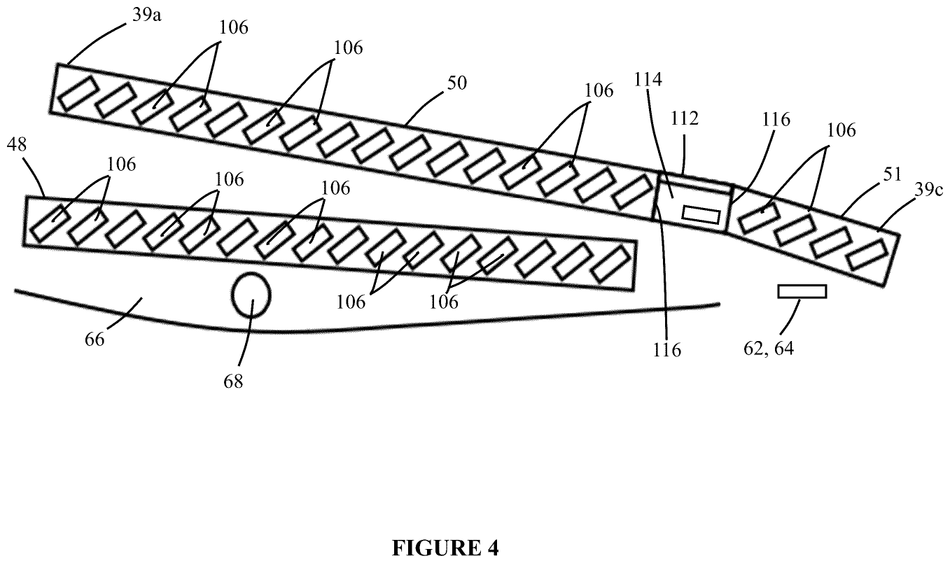

As seen in at least FIGS. 2, 3, and 4, grain and MOG passing through the concaves 40 can fall (or are actively fed) into a cleaning system, also referred to herein as a cleaning shoe 42, for further cleaning. The cleaning shoe 42 can include a cleaning fan 44 that is driven by a motor 46 and that generates a generally rearward airflow. The cleaning shoe 42 can also include a sieve 48 and a chaffer 50. Additionally, according to certain embodiments, the cleaning shoe 42 can further include an ancillary sieve 51 positioned downstream of the chaffer 50.

The chaffer 50, sieve 48, ancillary sieve 51, and a return pan 43 can be suspended with respect to one or more frames 39 by an actuation arrangement 52, which can include pivot arms and rocker arms mounted to disks (or other devices). Moreover, the chaffer 50, sieve 48, and ancillary sieve 51 can each comprise a generally rectangular frame 39a, 39b, 39c and supports 104 supporting a fore-and-aft extending array of laterally extending louvers 106. With respect to at least the sieve 48, each of the louvers 106 can be pivotally supported by the adjacent frame 39a, 39b, 39c and supports 104 to pivot about their respective longitudinal and laterally extending axes. The extent the louvers 106 are pivotally displaced can adjust the size of an opening between adjacent louvers 106 through which grain or other material can pass. Further, the louvers 106 of the chaffer 50 can be different than the illustrated louvers 106 of the ancillary sieve 51. For example, according to certain embodiments, while the louvers 106 of the chaffer 50 can be selectively pivotally displaced, the louvers 106 of the ancillary sieve 51 can be configured to remain generally static in position, and, more specifically, not configured for pivotable displacement. Additionally, optionally, the sizes of the louvers 106 of the chaffer 50, and associated openings between adjacent louvers 106 can be different than a corresponding size between the louvers 106 of the ancillary sieve 51.

The cleaning shoe can include a first plurality of hangers 108, each hanger 108 having an upper end and a lower end. The upper end of the hangers 108 can be pivotally coupled to the chassis 22 of the agricultural machine 20, while the lower ends are pivotally coupled to the chaffer 50. By this arrangement, the chaffer 50 can be suspended to pivot generally fore and aft. The hangers 108 can be disposed in a generally rectangular arrangement, to support the left front, left rear, right front, and right rear of the chaffer 50, and are disposed to support the chaffer 50 at the four corners of the chaffer 50.

The cleaning shoe 42 can include a second plurality of hangers 110, each hanger 110 having an upper end that is pivotally coupled to the chassis 22 of the agricultural machine 20. The lower end is pivotally coupled to the sieve 48 such that the sieve 48 is suspended to pivot generally fore-and-aft.

As the cleaning fan 44 blows air across and through the sieve 48 and the chaffer 50 the actuation arrangement 52 can cause reciprocating motion of the sieve 48, chaffer 50, and return pan 43 (e.g., via movement of the rocker arms). The combination of this motion of the sieve 48, chaffer 50, and return pan 43 with the air flow from the cleaning fan 44 generally causes the lighter chaff to be blown upward and rearward within the agricultural machine 20, while the heavier grain falls through openings between the louvers 106 of the chaffer 50 and the sieve 48 and accumulates in a material flow pathway, such as, for example, a clean grain trough 54 near the base of the agricultural machine 20. A clean grain auger 56 disposed in the clean grain trough 54 carries the grain in the clean grain trough 54 to one side of the agricultural machine 20 where the grain can be deposited in the lower end of a clean grain elevator 58. The deposited clean grain can then be lifted by the clean grain elevator 58 until the grain reaches an upper exit of the clean grain elevator 58. The clean grain can then be released from the clean grain elevator 58 and fall into a grain tank 60.

At least a portion of the grain entering the cleaning shoe 42, however, is not carried rearward, but instead passes downward through the chaffer 50, then through the sieve 48. Of the material carried by air from the cleaning fan 44 to the rear of the sieve 48 and the chaffer 50, smaller sized MOG particles are blown out of the rear of the agricultural machine 20. A portion of the larger sized MOG particles and grain not blown off the rear of the agricultural machine 20 can fall off the cleaning shoe 42 and onto one or more shoe loss sensors 62, 64 located across the cleaning shoe 42. In some embodiments, shoe loss sensors 62, 64 can be positioned across a width of the flow cleaning shoe 42, including, for example, right and left sides, as well as positions therebetween, of the cleaning shoe 42. Such positioning of the shoe loss sensors 62, 64 can provide output signals indicative of the quantity of grain loss at both the right and left sides of the cleaning shoe 42. In one example, the shoe loss sensors 62, 64 are strike sensors that count grain strikes per unit of time (or per unit of distance traveled) to provide an indication of the cleaning shoe grain loss in individual signals or a combined or aggregated signal.

In certain embodiments, the ancillary sieve 51, which can also be referred to as a frog mouth sieve, can be positioned downstream of the chaffer 50 and above the shoe loss sensors 62, 64. Such an ancillary sieve 51 can be configured to filter MOG in an effort to minimize or prevent chaff or other MOG from either striking the shoe loss sensors 62, 64 or interfering with grain striking, including interference with grain directly striking, the shoe loss sensors 62, 64. The ancillary sieve 51 can therefore be configured to assist with a delivery of a cleaner sample, namely grain with minimal chaff, to the shoe loss sensors 62, 64.

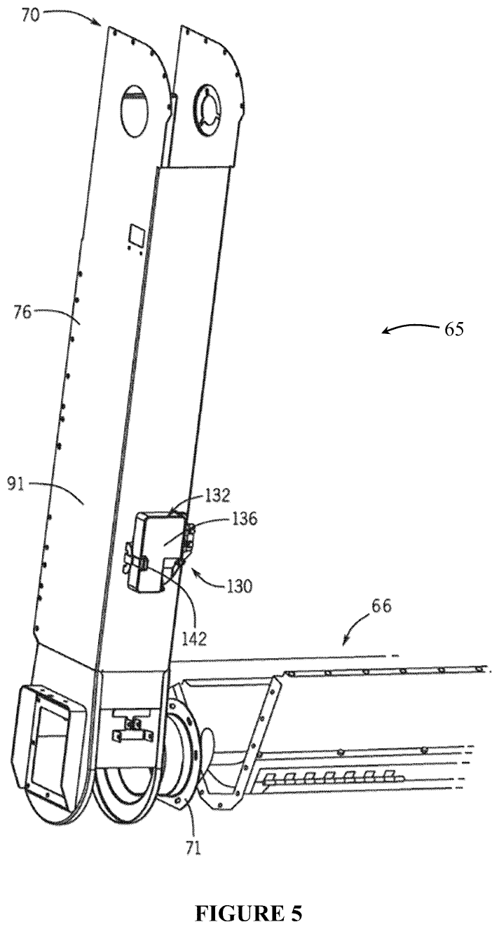

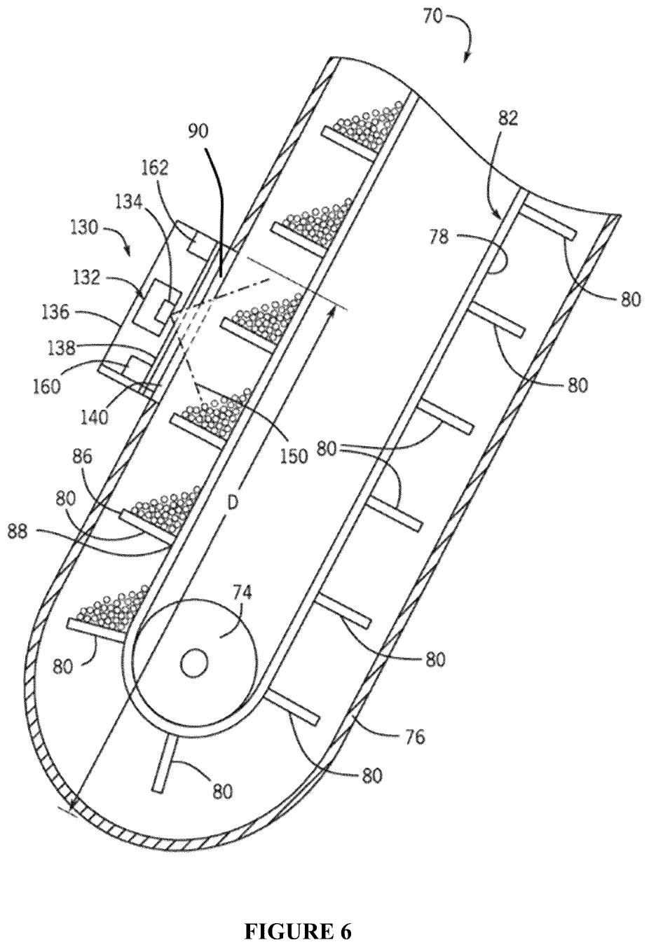

Heavier material that is carried to the rear of the chaffer 50, and, if present, the ancillary sieve 51, can be routed to pass out of the agricultural machine 20, and, as mentioned above, can be partially detected by the cleaning shoe loss sensors 62, 64. Heavier material that is carried to the rear of the sieve 48 can fall onto a pan and is then conveyed by gravity downward into a material flow pathway, such as, for example, a grain tailings trough 66 of a tailings system 65. This heavier material, referred to herein as tailings, is typically a mixture of grain and MOG. A tailings auger 68 disposed in the tailings trough 66 can carry the grain tailings to the opposite side of the agricultural machine 20 and into a grain tailings elevator 70, as shown in FIGS. 5 and 6

Referencing FIGS. 5 and 6, the grain tailings elevator 70 of the tailings system 65 can be constructed in a similar or different manner as the clean grain elevator 58 using any of various types of transport mechanisms (e.g., augers or flighted belts, among others). The grain tailings elevator 70 can communicate with the tailings auger 68 at an infeed or inlet opening 71 of the grain tailings elevator 70 where grain tailings are received for transport for further processing. In the depicted embodiment, sprockets 74 (one shown) are disposed at opposite ends of a grain tailings elevator housing 76 and a chain 78, or other flexible or conveyance member, is seated on the sprockets 74 to transfer power between the sprockets 74. A series of transport members such as, for example, paddles 80 are supported by the chain 78, such that as the sprockets 74 rotate, the chain 78 is moved to drive the paddles 80 along a generally clockwise or counterclockwise oblong path. In this way, grain tailings received into the grain tailings elevator housing 76 from the tailings auger 68 through the inlet opening 71 can be moved by the paddles 80 along a lifting portion of the oblong path. The chain 78, sprockets 74, and paddles 80 thus provide a conveyor arrangement 82 for the grain tailings elevator 70. At a top end of the grain tailings elevator housing 76, offload location, such as, for example, an outlet opening 84 (FIG. 1), is provided. Thus, the grain tailings lifted within the grain tailings elevator 70 by the paddles 80 can exit the grain tailings elevator housing 76 through the outlet opening 84 (e.g., for return to the thresher). After discharging the grain tailings through the outlet opening 84, the paddles 80 may continue, as moved by the sprockets 74 and the chain 78, along a return portion of the oblong path. In certain embodiments, a divider (not shown) may be provided between the lifting portion and the return portion of the oblong path, such that grain moved by the paddles 80 may be prevented from mixing. The paddles 80 may be spaced apart equally, unequally, or a combination thereof. Each of the paddles 80 has a front edge 86 and a rear edge 88, the front edge 86 being closer to a front side wall 90 of the grain tailings elevator housing 76 than the rear edge 88.

In a passive tailings implementation, the grain tailings elevator 70 carries the grain tailings upward and deposits them on a forward end of the rotor 38 to be re-threshed and separated. The grain tailings are then received by a discharge beater 92 where the remaining kernels of grain are released. The now-separated MOG is released behind the agricultural machine 20 to fall upon the ground in a windrow, or is delivered to a residue subsystem 94 that can include a chopper 96 and a spreader 98, where the separated MOG can be chopped by the chopper 96 and spread on the field by the spreader 98. Alternatively, in an active tailings implementation, the grain tailings elevator 70 may deliver the grain tailings upward to an additional threshing unit (not shown) that is separate from the separator 36, where the grain tailings are further threshed before being delivered to the main crop flow at the front of the cleaning shoe 42.

As seen in at least FIG. 6, the tailings system 65 can include an imaging system 130 that can include an optical device 132, such as, for example, a camera, having an image sensor 134 and a housing 136. According to certain embodiments, the optical device 132 can be a high resolution and frame rate camera, such as, for example, in one non-limiting example, a high resolution (e.g., 1080p high-definition) at 10,000 or more frames per second camera. According to other embodiments, the optical device 132 can be a camera having lower resolution (e.g., 5 megapixels) and lower or higher speeds (e.g., up to 1,000,000 frames per second), among other resolutions and speeds.

The optical device 132 can have its own housing contained within the housing 136 or instead be housed in the housing 136 without a separate housing. The housing 136 can be open at the side facing the grain tailings elevator 70, have a side wall 138 with an opening, or be made of a translucent material that allow passage of sufficient amounts of light in sufficient for the optical device 132 to image the interior of the grain tailings elevator 70. According to certain embodiments, the housing 136 can be mounted directly to a front side wall 90 of the grain tailings elevator housing 76 such that the open side or sidewall 138, and thus the image sensor 134, are aligned in registration with a window 140 in the front side wall 90 of the grain tailings elevator housing 76. In other embodiments, the optical device 132 may be mounted directly to another side wall, such as lateral side wall 91 of grain tailings elevator housing 76. In the illustrated example, the housing 136 is mounted to the front side wall 90 with a latch 142 and a hinge providing a pivotal connection to the grain tailings elevator 70, such as for replacing and/or cleaning the optical device 132. Alternatively, the housing 136 may be mounted to a front side wall 90 of the grain tailings elevator housing 76 using one or more screws or any other suitable fastening mechanisms. The housing 136, and thus the optical device 132, however, can be positioned at a variety of other locations about the grain tailings elevator housing 76, including, for example, along a rear side wall that is generally opposite to the front side wall 90.

The image sensor 134 of the optical device 132 can be operated to capture information, such as, for example, images or videos, of grain tailings transported by the conveyor arrangement 82 through the grain tailings elevator 70. Moreover, the imaging system 130 images the grain tailings within the tailings elevator housing 76 as carried upwardly or downwardly by the paddles 80, or in a state of suspension between the paddles 80 as the paddles 80 move the grain tailings through the tailings elevator housing 76. Where the optical device 132 is mounted directly onto the grain tailings elevator 70, as in the illustrated example, without the use of a bypass duct, the grain tailings do not need to be redirected through a bypass duct for imaging at a lower speed. Alternatively, according to other embodiments, the optical device 132 can be positioned in the bypass duct at which a portion of the grain tailings transported by the grain tailings elevator 70 are at least temporarily diverted before being returned by the grain tailings elevator 70 to the grain tailings trough 66.

In the illustrated example, the width of the window 140 is less than the width of the side wall 90. In other implementations, a window having a greater width, including a width approximately or equal to the width (i.e., the dimension between lateral sides of the paddles 80) of the side wall 90 may better allow for full-width images of the grain tailings on the elevator paddles 80, or to provide space for multiple cameras or other image sensors. In one implementation, the optical device(s) 132, 160, 162 captures images of the grain tailings at a field-of-view 150 between the front edge 86 and the rear edge 88 of the paddles 80 at the interior of the grain tailings elevator housing 76. In this manner, images of the grains on the whole of the top surfaces of the paddles 80 may be captured.

In an example implementation, the imaging system 130 can include a plurality of optical devices 132, 160, 162, as shown in FIG. 6, that can be positioned internally or externally relative to the housing 136. A greater number of optical devices 132, 160, 162 can enhance the performance of the imaging system 130. For example, multiple optical devices 132, 160, 162 (e.g., cameras) can be placed side-by-side, in stereo fashion, to enhance the depth perception of the camera vision, like the binocular vision of humans. The relative focus of the two image sensors of two or more optical devices 132, 160, 162 can better indicate the physical location of grain tailings on the paddle 80, as well as the depth of the grain tailings. The location and depth of the grain tailings can be probative of their constituents, since the material property of broken grains tends to be different than the material property of clean grains and centrifugal force generally causes heavier or denser grain material to travel differently (e.g., farther in a radial direction (away from a rotation axis of the sprockets 74) relative to lighter or less dense grain material). Thus, the closer grain tailings are to the optical device(s) 132, 160, 162 (i.e., the closer to the front edge 86 of the paddle 80 carrying the grain tailings), the more likely the grain tailings are broken grain or MOG (non-clean) because the grain tailings are heavier and denser. Conversely, the further the grain tailings are located from the optical device(s) 132, 160, 162 (i.e., the closer to the rear edge 88 of the paddle 80 carrying the grain tailings), the cleaner the grain tailings because the grain tailings are lighter and less dense. Additionally, with regard to stereo imaging, two or more optical device(s) 132, 160, 162, and their associated image sensors 134, can be used to indicate depth information while another optical device 132, 160, 162 can provide the primary indication of color, focus/defocus, lighting, and exposure information, for example.

The imaging system 130 can be operated in coordination with the conveyor arrangement 82. For example, one or more sensors may initiate the capture of images by triggering or signaling to the optical device(s) 132, 160, 162 (or other image sensors) when a sensor detects a paddle 80 at a particular location within the grain tailings elevator housing 76, relative to the optical device(s) 132, 160, 162, or based on a prescribed time delay. In one implementation, for example, a sensor (e.g., sensor 160) detects the position of the paddles 80 as each paddle 80 approaches or reaches the field-of-view 150 of the optical device(s) 132, 160, 162 so that the image(s) is/are at least captured at a time in which the full-width of the top side of the paddle 80 is within the field-of-view 150 of the optical device(s) 132, 160, 162, thereby facilitating a full-width and front-to-back image of the grain tailings supported by the paddle 80. In other implementations, no additional sensors are employed, and the optical device(s) 132, 160, 162 is/are programmed to capture images at a predetermined rate(s) and period(s) that are synchronized with the travel of the paddles 80. In still other implementations, the optical device(s) 132, 160, 162 continuously captures images at a sampling rate that is coordinated with the paddle speed.

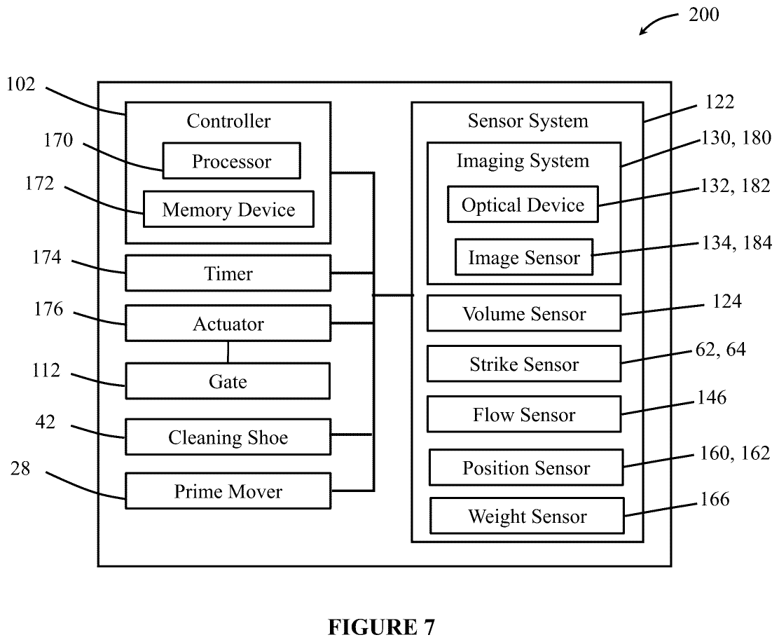

FIG. 7 illustrates a simplified block diagram representation of an exemplary residue detection system 200. As illustrated, the residue detection system 200 can include one or more controllers 102 having one or more processors 170 and one or more memory devices 172. The processors 170 can be configured to follow instructions, including control instructions contained with, or are part of, one or more of the memory devices 172, including, for example, a non-transitory machine-readable medium.

The processors 170 can be embodied as any type of processor or other computer circuit capable of performing various tasks. In some embodiments, each processor 170 can be embodied as a single or multi-core processor, a microcontroller, or other processing or controlling circuit. Additionally, in some embodiments, each processor 170 can be embodied as, include, or be coupled to an FPGA, an application specific integrated circuit (ASIC), reconfigurable hardware or hardware circuitry, or other specialized hardware to facilitate performance of the functions described herein. In some embodiments still, each processor 170 can be embodied as a high-power processor, an accelerator co-processor, an FPGA, or a storage controller.

The memory device 172 may be of one or more types of non-transitory computer-readable media, such as a solid-state memory, electromagnetic memory, optical memory, or a combination thereof. Further, the memory device 172 may be volatile and/or nonvolatile. It should be appreciated that the memory device 172 may store data that is manipulated by the operating logic of processor 170, such as, for example, data representative of inputted signals in addition to or in lieu of storing programming instructions defining operating logic. Each memory device 172 can store various software and data used during operation of the residue detection system 200, such as applications, programs, libraries, and drivers. Thus, the memory devices 172 can include information, including, but not limited to, algorithms and look-up tables, among other information, that can used by the processor 170, including with respect to features relating to at least transfer functions utilizing information from one or more shoe loss sensors 62, 64, operation of the cleaning shoe 42, or operational settings for the agricultural machine 20, as well as various combinations thereof, as discussed below, among other functions or operations.

The residue detection system 200 can include a selectively openable gate 112 that can be positioned at a variety of locations, including, for example, downstream of the chaffer 50, upstream of the chaffer 50, or at various positions about the chaffer 50, among other locations. The gate 112, which, according to certain embodiments, can be part of or coupled to the cleaning shoe 42, can be utilized in connection with a controlled collection of chaffer material, including residue containing grain and chaff, among other MOG, flowing above, including on or along, the chaffer 50 before the residue is dispensed out of the back of the agricultural machine 20 and onto the field. As discussed below, the chaffer material collected via selective opening of the gate 112 can be analyzed, including, for example, with respect to one or more residue properties, including, for example, a ratio of grain to chaff in the residue that is being dispensed out of the agricultural machine 20 and onto the field. Such analysis can, as also discussed below, be utilized to adjust one or more of: a transfer function(s) used with information obtained by one or more shoe loss sensors 62, 64 to improve the accuracy of grain loss determinations; operation of the cleaning shoe 42; and, operation of the agricultural machine 20, among other adjustments.

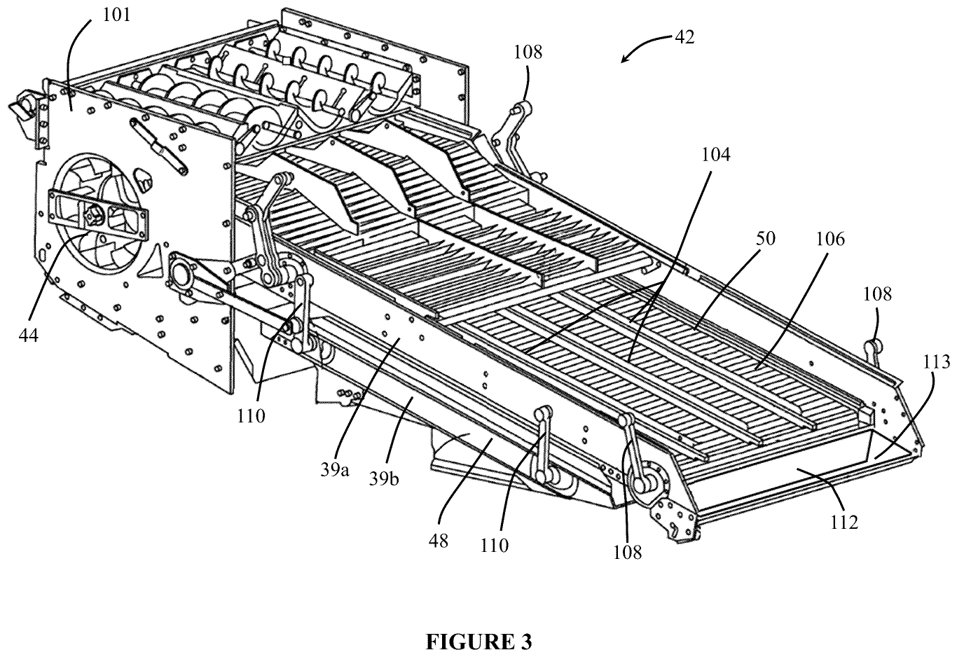

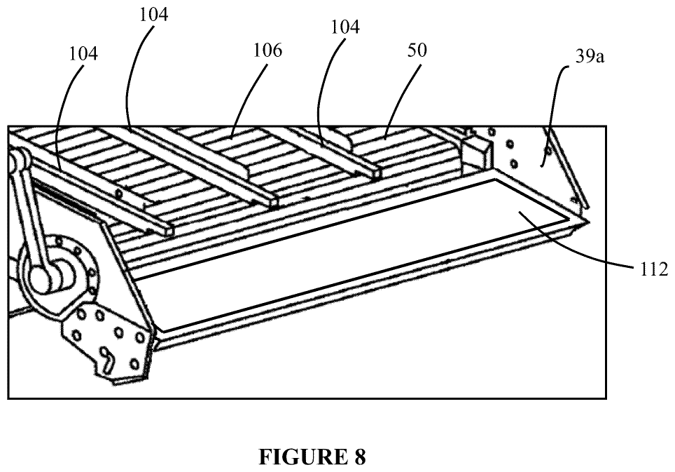

The gate 112 can be selectively displaced about an opening 113 between an open position, as shown in FIG. 3, and a closed position, as shown in FIG. 8. In certain embodiments, the opening 113 can be part of a frame 39a, 39c of either or both the chaffer 50 and the ancillary sieve 51. Alternatively, in other embodiments, the opening 113 can be an opening of a residue housing 114 coupled to one or more of the frames 39a, 39c. In such an embodiment, the residue housing 114 can include a plurality of side walls 116 that generally define at least a portion of a material flow pathway provided by an interior region 118 of the residue housing 114, the interior region 118 being in fluid communication with the opening 113. The gate 112 and residue housing 114 can be constructed from a variety of materials, including metallic materials similar to those used for the frames 39a, 39b, among other materials.

The gate 112 can be coupled to one or more frames 39a, 39c or a sidewall(s) 116, among other portions of the residue housing 114, in a manner that can accommodate displacement of the gate 112 between the open and closed positions. For example, in certain embodiments, the gate 112 can comprise one or more gates 112 pivotally coupled to an adjacent frame 39a, 39c or sidewall 116, such as, for example, via a hinge, in a manner that can accommodate pivotal displacement of the gate(s) 112 between the open and closed positions. Alternatively, in other embodiments, the gate 112 can be slidingly displaced between the open and closed positions, among other manners of displacement of the gate 112 relative to at least the opening 113.

The displacement of the gate 112 can be controlled by selective operation of an actuator 176, such as, for example, an electric motor, hydraulic cylinder, or pneumatic cylinder, among other types of actuators. As discussed below, a controller 102, including an associated processor(s) 170, can generate one or more signals to facilitate operation of the actuator 176 in a manner that can selectively control the displacement of the gate 112 between the open and closed positions. Additionally, according to certain embodiments, a biasing element, such as, for example, a spring, among other biasing elements, can be utilized to bias the gate 112 to one of the open position or the closed position. Further, according to certain embodiments, a latch can be used to selectively lock, or retain, the gate in one of the open and closed positions.

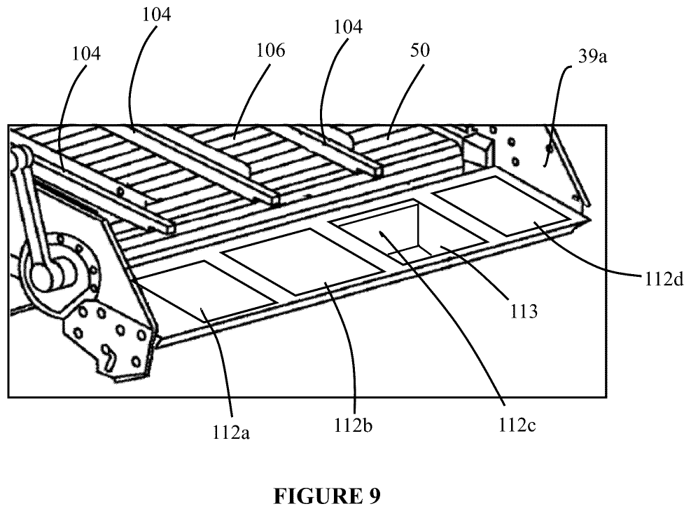

FIGS. 3 and 8 illustrate embodiments in which a single gate 112 is used to control flow of chaffer material through the opening 113, FIG. 9 illustrates an alternative embodiment in which a plurality of gates 112a, 112b, 112c, 112d can cover different portions of the opening 113 or, alternatively, a plurality of openings 113. Moreover, each gate 112a-d of the plurality of gates 112a-d can be individually controlled with respect to being selectively displaced between the opened and closed positions. For example, in FIG. 9, a first gate 112a, a second gate 112b, and a fourth gate 112d are each shown being at closed positions, while a third gate 112c positioned between the second and fourth gates 112b, 112d is in an open position.

With respect to embodiments having a plurality of gates 112a-d, selectively opening at least one, but not all, of the gate(s) 112a-d can facilitate an understanding of one or more characteristics of the residue flowing along a certain portion, including side, of the chaffer 50. For example, opening the first, far left outer gate 112a while the other gates 112b-d remain closed can facilitate an independent understanding of the characteristics of the residue flowing on the left side of the chaffer 50 separate from characteristics of residue located at either or both the right side and a central region of the chaffer 50. Such selective opening of some, but not all, of the gates 112a-d can be utilized to analyze potential variations in residue characteristics that can, for instance, arise due to differing load conditions, which can be influenced by factors such as terrain slope or various operational settings of either or both the cleaning shoe 42 and agricultural machine 20.

In embodiments where the rotor 38 of the separator is a single rotor system, instead of a dual rotor system, the discharge of material, including grain and chaff, among other material other than grain (MOG), from the rotor 38 can be influenced by the rotational direction of the rotor 38. Moreover, the discharge of material from a single rotor 38 can result in an asymmetrical distribution of material along at least the chaffer 50. Such an asymmetrical distribution of material along at least the chaffer 50 can also occur when the agricultural machine 20 is collecting crop material while traveling along certain terrain slopes or inclines. An asymmetrical distribution of crop material along at least the chaffer 50 can create variances in terms of at least one or more of the quantity, properties, and composition, among other residue properties, of the material flowing along the chaffer 50. For example, with respect to properties, an asymmetrical distribution of material flowing along the chaffer 50 can involve material having a higher moisture content accumulating on one side of at least the chaffer 50, while material having a lower moisture content can accumulate on the other, opposite side of the chaffer 50. Further, variances in a residue property, such as, for example, the composition, of the material can involve the quantity of grain in the material, including variances relating to the grain to chaff ratio along different sides or portions of the chaffer 50. Thus, according to certain embodiments, the controller 102 can be configured to selectively open at least one, but not all, of the plurality of gates 112a-d in response to detection of at least certain operational characteristics or circumstances that may result in uneven load conditions, including, for example, characteristics relating to the terrain (e.g., slope) the agricultural machine 20 is traveling along while harvesting crop material, or various operational settings, including with respect to the threshing device, separator 36, or cleaning shoe 42. For example, according to certain embodiments, one or more sensors may be positioned at, or around, the chaffer 50 that can provide information that the controller 102 can use to determine an occurrence of an uneven distribution of material along the chaffer 50. In such situations, the sensed information regarding the uneven distribution can be used to identify either or both which gates 112a-d are to be opened, and which gates 112a-d are to remain closed.

Such variances in the distribution of material along the chaffer 50 can impact the characteristics of the strikes detected, or not detected, by the shoe loss sensors 62, 64. For example, an uneven distribution of material can result in the characteristics of the material, including grain or chaff, or a combination thereof, that strikes a first shoe loss sensor 62 on a right side of the cleaning shoe 42 being different than the characteristics of the material striking a second shoe loss sensor 62 on an opposing left side of the cleaning shoe 42. Such differences in characteristics can adversely impact the ability to accurately identify strikes against the shoe loss sensors 62, 64 that are, or are not, to be attributed to at least grain, which can adversely impact determinations of grain loss that are at least partially based on the information provided by the shoe loss sensors 62, 64, including with respect to use of an appropriate transfer function.

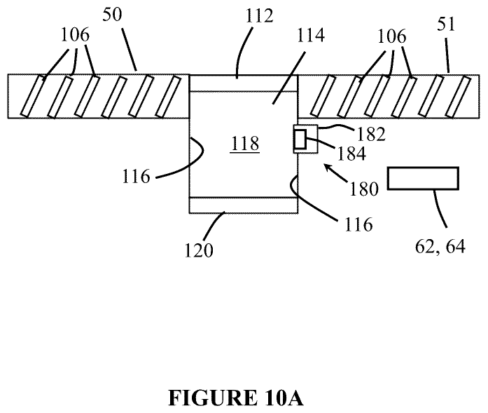

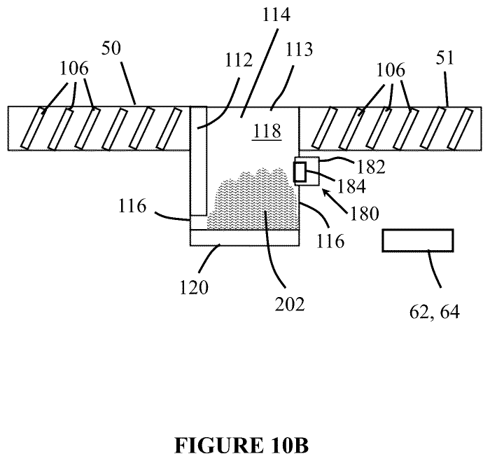

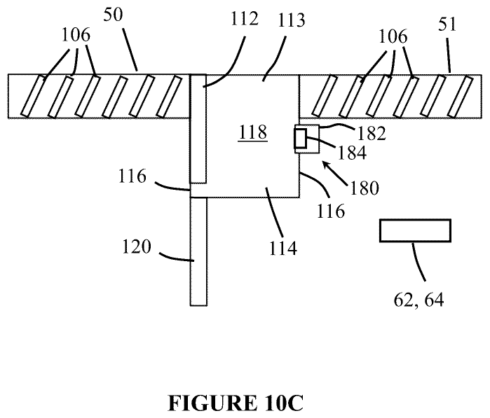

The residue detection system 200 can also include a sensor system 122 that can include one or more sensors that might, or might not, be dedicated to the operation of the residue detection system 200. For example, the sensor system 122 can include the imaging system 130 of the tailings system 65, including one or more optical devices 132, 160, 162, and the associated image sensor(s) 134, of the tailings system 65. Additionally, or alternatively, as seen in at least FIGS. 10A, 10B, and 10C, the residue detection system 200 can include an imaging system 180 that can be dedicated to use with the residue detection system 200 and that can include one or more optical devices 182, including the associated image sensor(s) 184, that can be similar to the imaging system 130 and optical device(s) 132, 160, 162 discussed above with respect to the tailings system 65.

As seen in FIGS. 10A-10C, with respect to embodiments in which the imaging system 180 is dedicated for use with the residue detection system 200, the housing 116 can include a base door 120 at an end of the residue housing 114 opposite to the gate 112. With the gate 112 opened, and the base door 120 closed, as seen in FIG. 10B, residue flowing into the interior region 118 of the residue housing 114 can accumulate on a surface of the base door 120. The imaging system 180 can be configured to generally continuously, at certain time intervals, or at a time threshold based at least in part on a time after the gate 112 has opened or a duration of time the gate 112 has been opened, be operated to capture information of the residue that has accumulated within the interior region 118. Additionally, or alternatively, the imaging system 180 can be configured to be activated in response to a detected amount, including fill level, of residue within the interior region 118 of the residue housing 114, or a duration of time that may commence with the opening or closing of either or both the gate 112 and the base door 120. As illustrated by FIG. 10C, after the imaging system 180 has captured information regarding the accumulated residue, or upon expiration of a predetermined time after the door has opened, the base door 120 can be opened to dispense the collected residue out from the residue housing 114.

The housing 116 shown in FIGS. 10A-10C can be used to provide an area for isolation of residue that may be separate from, or, alternatively, part of, another system of the agricultural machine 20. For example, according to certain embodiments, the housing 116 can be located, at least partially, within the tailings systems 65, among other systems. Alternatively, the base door 120 can be positioned to release residue from the housing 116 and into the tailings system 65, among other systems. Additionally, either or both the housing 116 and at least a portion of the imaging system 180, including for example, the optical device 182 and image sensor(s) 184, can be mounted at a locations, or in manners, that can at least attempt to minimize occurrences of shaking or vibration of at least a portion of the bypass system 122 that could otherwise adversely impact the quality of the information captured by the optical system 180. Thus, for example, according to certain embodiments, while the gate 112 may be positioned along, or adjacent to the chaffer 50, either or both the housing 116 and at least a portion of the imaging system 180 may be mounted at locations other than the chaffer 50.

According to certain embodiments in which the imaging system 180 is, or is not, dedicated for use with the residue detection system 200, the sensor system 122 can include a flow sensor 146 that can provide information the controller 102, including the processor 170, can use to determine a rate of material flow into or through a portion of the agricultural machine 20, including, for example, the tailings system 65 and the residue housing 114. Additionally, or alternatively, the sensor system 122 can include a volume sensor 124 that can provide information the controller 102, including the processor 170, can use to determine a quantity of material passing through portions of the agricultural machine 20, including, for example, the tailings system 65 and residue housing 114, among other portions of the agricultural machine 20. The sensor system 122 can also include a variety of other sensors in addition to, or in lieu of, either or both the volume sensor 124 and the sensor 146 that can be used to identify one or more other properties or characteristics of the material flow into or through the tailings system 65 or the residue housing 114, including, for example, a weight sensor 166. Information provided by one or more of the flow sensor 146, the volume sensor 124, and weight sensor 166, among other sensors can be used, for example, to control the timing of the opening of the gate(s) 112 so that the introduction of chaffer material that flows through the opening 113 does not overload portions of the agricultural machine 20 that may receive the chaffer material, including the tailings system 65. Additionally, changes in flow rates or volume, as determined using information from the flow sensor 146, volume sensor 124, or weight sensor 166, respectively, among other properties or characteristics, can be used to determine whether information provided by the imaging system 130, 180 captures chaffer material collected by the opening of the gate(s) 112 that may be present with grain tailings in the tailings system 65.

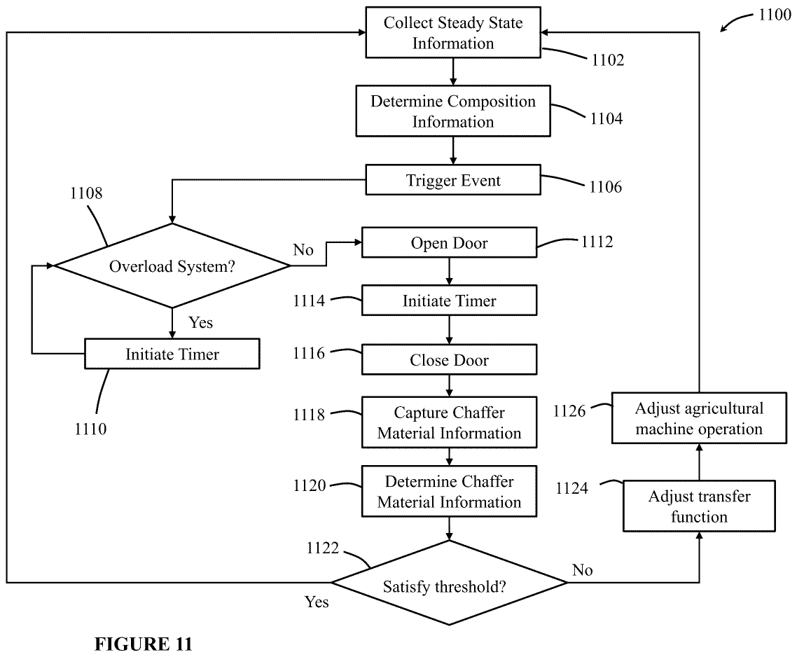

FIG. 11 illustrates a simplified flow diagram of an exemplary method for using a residue detection system 200 to detect residue properties associated with grain loss, and adjusting one or more operations of an agricultural machine 20. The method 1100 is described below in the context of being carried out by the illustrated exemplary residue detection system 200. However, method 1100 can likewise be carried out by any of the other described implementations, as well as variations thereof. Further, the method 1100 corresponds to, or is otherwise associated with, performance of the blocks described below in the illustrative sequence of FIG. 11. The method 1100 can be performed in one or more sequences different from the illustrative sequence. Additionally, one or more of the blocks mentioned below may not be performed, and the method 1100 can include steps or processes other than those discussed below.

At block 1102, steady-state information can be collected relating to grain loss within the agricultural machine 20. The steady-state information can include data representative of consistent operating conditions over a designated period, ensuring that transient fluctuations do not affect the analysis. This information can be derived from various sensors associated with the sensor system 122 of the residue detection system 200, including, for example, the shoe loss sensors 62, 64, imaging system 130, volume sensor 124, flow sensor 146, or weight sensor 166, as well as various combinations thereof, among other sensors. The collected information can encompass measurements of one ore more residue properties, including, for example, grain and MOG flow, sensor readings of grain strikes, imaging data indicative of the grain to chaff ratio, or image data used to determine grain loss, as well as various combinations thereof, among other information or residue properties. The gathered information aims to reflect stable operating conditions of the agricultural machine 20, inclusive of the cleaning shoe 42 and tailings system 65, facilitating either or both accurate assessment of one or more residue properties that can relate to grain loss and accurate assessment and calibration of transfer functions for grain loss determination. For example, information captured by the residue detection system 200 can be utilized for determinations regarding various residue properties, including, for example, an amount of grain contained in the residue, and thus be used to directly determine grain loss. Additionally, or alternatively, information captured by the residue detection system 200 can be used to determine a grain to chaff ratio, which can be used, for example, via a transfer function, in connection with an indirect determination of grain loss, among other manners of grain loss determinations.

According to such an embodiment, prior to the gate(s) 112 being opened, at block 1102 steady-state information can be obtained from one or more sensors that may be located in, or are part of, the tailings system 65, regarding tailings in the tailings system 65. For example, steady-state information can at block 1102 be captured by the imaging system 130 that reflect one or more residue properties, such as, for example, the distribution and composition of grain and MOG in the grain tailings, including either or both an amount of grain in the grain tailings and the grain to chaff ratio of the grain tailings, among other residue properties, prior to the opening of the gate(s) 112. These images are processed, including, for example, via use of the controller 102 and the associated processor(s) 170 to provide insight into the characteristics of the grain tailings conveyed in the tailings system 65, facilitating an evaluation of the efficiency of separation within the cleaning shoe 42. Further, as discussed above, the captured information can be used to directly determine grain loss, or inform calibration of transfer functions employed in determining grain loss by aligning this information with signals obtained from shoe loss sensors 62, 64, thereby enhancing the accuracy of grain loss detection. The steady-state information can also include, optionally, information regarding existing flow rates or volume, including, for example, with respect to grain tailings in the tailings system 65, as determined using information from the flow sensor 146, volume sensor 124, or weight sensor 166.

At block 1104, the residue detection system 200, including, for example, the controller 102, can utilize the steady-state information gathered at block 1102 to determine one or more residue properties, such as, for example, composition information, for the grain tailings in the tailings system 65. For example, as previously discussed, the imaging system 130 can capture visual information reflecting either or both the amount of grain in the grain tailings and distribution and proportion of grain relative to MOG in the grain tailings, which can be used by the processor 170 within the controller 102 in executing algorithms that can identify the specific characteristics of the grain tailings. Such an analysis can result in detailed composition information, among other residue properties, about the grain tailings, including, for example, information regarding either or both the amount of grain and the ratio of grain to chaff, among other MOG, within the grain tailings in the tailings system 65, thereby assisting in the accurate calibration of transfer functions employed for grain loss estimations.

At block 1106, the controller 102, including an associated processor 170, can determine an occurrence of a trigger event that may result in the controller 102 generating a signal to operate the actuator 176 to displace the gate(s) 112 to the open position. The trigger event can be based on the occurrence of one or more events or satisfaction of certain thresholds. For example, according to certain embodiments, the trigger event can be based on certain time intervals, as may be identified by the controller 102 using information provided by a timer 174. For example, the trigger event can be the expiration of a five-minute time period, among other times, since the prior trigger event, or since the gate(s) 112 was last closed. Additionally, or alternatively, the trigger event can be based on a change in the steady-state information collected at block 1102, including, but not limited to, a variance in the characteristics, including levels or amounts, in the steady-state information that exceeds a predetermined threshold, including, for example, with respect to feed rates, volume, or composition of the grain tailings, as well as various combinations thereof, among other changes in steady-state information. According to other embodiments, the trigger event can be a detected change in environmental or crop attributes, including, for example, changes in moisture levels or content or terrain, including inclines. Further, according to certain embodiments, the trigger event can be a change in one or more environmental, crop, or operational attributes or settings that may impact the operation, including grain strike detection, of the shoe loss sensors 62, 64. Additionally, or alternatively, the trigger condition can be at least partially based on either or both the volume or flow rate of grain tailings in the in the tailings system 65 being below predetermined thresholds, which may indicate the tailings system 65 has capacity to receive residue into the tailings system 65 through an open gate 112.

As previously discussed, the opening 113 can be positioned such that chaffer material that passes through the opening 113 when the gate(s) 112 is in an open position falls, or is otherwise delivered to, the grain tailings trough 66 of the tailings system 65. According to at least such embodiments, at block 1108, the controller 102 can determine whether opening the gate 112, and introducing the chaffer material that could flow through the opening 113 and into the tailings system 65 would result in an overloading of the tailings system 65. For example, as previously discussed, the flow sensor 146, the volume sensor 124, or the weight sensor 166, as well as various combinations thereof, among other sensors, can provide information regarding a current rate of material flow of grain tailings, or a volume of grain tailings, within the tailings system 65. By analyzing this information, the controller 102 can assess whether the current material flow or volume levels of grain tailings in the tailings system 65 are approaching or exceeding predefined capacity thresholds of the tailings system 65. Alternatively, the controller 102 can determine, including predict, whether, based on the current material flow or volume levels of grain tailings in the tailings system 65, and the addition of chaffer material resulting from an opening of the gate(s) 112, can be expected to result in the collective amount of grain tailings and chaffer material in the tailings system 65 exceeding predefined capacity thresholds for the tailings system 65. Thus, considerations at block 1108 can be configured to prevent the addition of chaffer material that flows through the opening 113 from potentially causing an overloading of the tailings system 65.

If at block 1108 the controller 102 determines introducing the chaffer material through the opening 113 can result in the predefined capacity thresholds for the tailings system 65 being exceeded, then at block 1110 the controller 102 can determine to at least temporarily delay an opening of the gate(s) 112. For example, at block 1110, in response to determining at block 1108 that introducing the chaffer material can overload the tailings system 65, the timer 174 can be initiated. The controller 102 can be configured to reevaluate, at block 1108, after expiration of a predetermined time period, as indicated using information from the timer 174, whether the introducing of chaffer material through the opening 113 will still result in the predefined capacity thresholds for the tailings system 65 being exceeded. Additionally, the controller 102 can be configured to, after a certain number of evaluations or reevaluations at block 1108 result in determinations that predefined capacity thresholds will be exceeded, opt to decide to not, at least presently, allow for the opening of the gate(s) 112. In such embodiments, after a predetermined number of evaluations at block 1108 result in decisions to not open the gate(s) 112, the method 1100 can return to block 1102.

If, however, at block 1108 the controller 102 determines opening the gate(s) 112 will not result in predefined capacity thresholds being exceeded, then at block 1112 the controller 102 can generate one or more signals to facilitate operation of the actuator 176 in a manner that displaces one or more of the gates 112 to the open position. With respect to embodiments in which the gate 112 is a plurality of gates 112a-d, the decision at block 1112 can also include the controller 102 determining which of one or more, but not all, of the gates 112a-d are to be opened, or if all of the gates 112a-d are to be opened. As discussed above, such a determination can include evaluating information that may indicate at least a potential occurrence of overload conditions, including, for example, with respect to uneven load conditions.

According to certain embodiments, the opening of the gate(s) 112 at block 1112 can be accompanied by a start or initiation of the timer 174 at block 1114. Such initiation of the timer 174 can provide an indication at block 1116 to the controller 102 as to when the controller 102 is to generate one or more signals to facilitate an operation of the actuator 176 to displace the opened gate(s) 112 to the closed position. For example, according to certain embodiments, the controller 102 can be configured to close an open gate(s) 112 within a predetermined time period after the gate(s) 112 has been displaced to the open position. However, the closing of the gate(s) 112 can be triggered by other events in addition to, or in lieu of, an expiration of the predetermined time period. For example, according to certain embodiments, information provided by the flow sensor 146, volume sensor 124, or weight sensor 166 can indicate the tailings system 65 is approaching, or has reached, the predefined capacity thresholds, or has increased beyond a certain threshold since the gate(s) 112 has been opened. Such situations can trigger the controller 102 to generate one or more signals to facilitate the actuator 176 closing the gate(s) 112.

According to certain embodiments, at block 1118, the imaging system 130, as implemented in connection with the tailings system 65, can function to capture information of the chaffer material, or a combination of chaffer material and grain tailings, such as, for example, via operation of the above-discussed optical device(s) 132, 160, 162. The capturing of chaffer material information, either alone or in combination with grain tailings, by the imaging system 130 can be similar to that discussed above with respect to capturing grain tailings information within the tailings elevator housing 76 either as carried by the paddles 80 or in a state of suspension between the paddles 80 as the paddles 80 move through the grain tailings elevator housing 76.

Similar to the above-discussed use of captured information provided by the optical device(s) 132, 160, 162 for grain tailings, the controller 102 can use captured information that may include chaffer material alone or in combination with at least some grain tailings to determine one or more residue properties, such as, for example, the composition of at least the chaffer material, including, for example, either or both an amount of grain in, and a grain to chaff ratio of, the chaffer material, among other residue properties. The controller 102 can be configured to identify captured information obtained by the imaging system 130 as corresponding, at least in part, if not entirely, to chaffer material, as opposed to grain tailings, in a variety of manners. For example, according to certain embodiments, the controller 102 can be configured to identify information captured by the imaging system 130 as being at least chaffer material based on the captured information being obtained within a certain time, as can be indicated by the timer 174, after the gate(s) 112 was opened. For example, the controller 102 can be configured to identify that, after a first time period after the opening of the gate(s) 112, the information being captured by the imaging system 130 corresponds to at least chaffer material. According to such an embodiment, the first time can correspond to an amount of time collected chaffer material is expected to travel through the tailings system 65 to a position at which the material on the paddle 80 within the field of view of the optical device 132, 160, 162 is, or at least includes, chaffer material. Additionally, the controller 102 can be configured to continue to identify information captured by the imaging system 130 as being representative of chaffer material for, or until an occurrence of, a second time after the gate(s) 112 was opened, or, optionally, after the gate(s) 112 has been closed. Such first and second times for the start, duration, or ending, and combinations thereof, for identifying information captured by the imaging system 130 as being representative of at least chaffer material can account for certain latencies at least with respect to the time of travel or flow of chaffer material through the opening 113 and to a position at which the imaging system 130 can capture one or more images of the chaffer material. Further, according to certain embodiments, one or both of the first and second times associated with such latencies can be predetermined or variable, or be a combination thereof. For example, according to such embodiments, the time associated with such latencies can be a preset default setting or an operator setting. Alternatively, such latencies can be variable and can be based, for example, on either flow rates or changes in volume within the tailings system 65, as can be identified using information from one or more of the volume sensor 124, the flow sensor 146, and the weight sensor 166.

Additionally, or alternatively, according to certain embodiments, the controller 102 can be configured to identify captured information obtained by the imaging system 130 as corresponding, at least in part, if not entirely, to chaffer material, based on a change in a detected volume or weight of material on the paddle(s) 80 of the grain tailings elevator housing 76. For example, according to certain embodiments, the volume sensor 124 can detect the volume of either or both grain tailings and chaffer material on the paddle(s) 80. The volume sensor 124 can include one or more emitters that are configured to emit light at least generally toward at least the area around a paddle(s) 80, and a receiver that is configured to detect the extent the emitted light is, or is not, detected, including received by the receiver, or a location of light is, or is not, detected by the receiver. According to such an embodiment, a larger volume of material on or around the paddle(s) 80 can decrease the amount, or location, of light detected by the receiver, while a decrease in volume of material on or around the paddle(s) 80 can increase the amount, or location, of light detected by the receiver. According to such an embodiment, a detected increase in the volume, or an increase in the weight, as detected by the weight sensor 166, of material on the paddle(s) 80 can provide an indication that the paddle(s) 80 includes at least additional material in the form of chaffer material that has been delivered into the tailings system 65 via the opening of the gate(s) 112, while a decrease in volume or weight of material on the paddle(s) 80, or a return to a steady-state volume on the paddle(s) 80, can indicate an absence of chaffer material on the paddle(s) 80. However, such change in volume or weight information can be detected in a variety of other manners, including, for example, changes in volume or weight of grain tailings at the inlet opening 71 or outlet opening 84 of the grain tailings elevator 70. Additionally, according to other embodiments, either or both the presence and absence of chaffer material on the paddle(s) 80 can be identified by variances in the flow rate of material flowing into or out of the grain tailings elevator 70, as can be detected via use of the flow sensor 146.

At block 1120, the controller 102 processes the captured information obtained at block 1118 from the imaging system 130 to determine one or more residue properties, such as, for example, the composition, of the chaffer material. The controller 102 can, for example, analyze visual information from the captured information that is indicative of one or more residue properties, including, for example, either or both the amount of grain and the ratio of grain to chaff present within the collected chaffer material. The controller 102 can utilize such visual information along with associated processing algorithms stored in its memory device 172 to analyze the captured images. The analysis can include assessing the color, size, and distribution of the material components in the captured images to determine captured information being indicative of either grain or chaff. Moreover, through this analysis, the controller 102 can identify distinct physical attributes of the chaffer material, enabling the controller 102 to distinguish between grain and chaff. The processed image information can thus allow the controller 102 to determine one or more of the residue properties, including, for example, either or both detect an amount of grain present in the chaffer material and correlate the detected ratio of grain to chaff within the chaffer material, and thus within the residue above the chaffer 50 from which the chaffer material was collected.

The controller 102 can utilize the residue property information, such as, for example, the chaffer material composition information, obtained at block 1120 to determine, at block 1122, whether the residue properties, such as, chaffer material composition, satisfies one or more predetermined thresholds. These predetermined thresholds can, for example, relate to current settings regarding an anticipated grain to chaff ratio(s) within the chaffer material or expected grain loss, among other residue properties. The controller 102 can execute this evaluation by comparing the analyzed residue properties, such as, for example, grain to chaff ratio with established thresholds, among other residue property thresholds, including, for example, predetermined thresholds stored in the memory device 172 or set by an operator. For example, according to certain embodiments, the predetermined thresholds can correspond to the grain to chaff ratios currently being used for the transfer functions associated with one or more of the shoe loss sensors 62, 64, and which may reflect a current anticipated range of grain to chaff ratio of the chaffer material or residue above the chaffer 50. Thus, a failure to satisfy the one or more of the predetermined thresholds at block 1122 can, for example, relate to the grain to chaff ratio, as determined at block 1120, being outside (e.g., above or below) of the grain to chaff ratio at which either or both the transfer function and associate settings of agricultural machine 20, including, for example, one or more of the cleaning shoe 42, separator 36, and propulsion settings, are currently based by an amount that exceeds a predetermined threshold, including an acceptable tolerance or variance.

If at block 1122 the controller 102 determines the residue properties, such as, for example, residue properties relating to the chaffer material, does satisfy the one or more predetermined thresholds, then the method 1100 can return to block 1102, and the method 1100 can be repeated.

If, however, the controller 102 determines at block 1122 that the residue properties do not satisfy the one or more predetermined thresholds, then according to certain embodiments, the residue properties determined at block 1120 can be used, at block 1124, to update the transfer function for one or more of the shoe loss sensors 62, 64. As previously discussed, the transfer function can correlate readings from the shoe loss sensors 62, 64, which can be provided as grain strike counts against the shoe loss sensors 62, 64, with actual grain loss quantities. For example, if the grain to chaff ratio of the chaffer material, as determined at block 1120, indicates a higher than anticipated chaff presence (as can be determined at block 1122), among other residue properties, including, for example, characteristics regarding the chaffer material (e.g., the size of MOG within the chaff), which can possibly lead to inaccurate grain strike readings at the shoe loss sensors 62, 64, the controller 102 can, at block 1124, adjust the transfer function to account for the excess chaff in the associated residue that may strike the shoe loss sensors 62, 64. Such an adjustment might involve revising one or more factors or coefficients, including multipliers or weighted values, used within the transfer function equation to moderate the impact chaff can, or can not, have on the information outputted by the shoe loss sensors 62, 64.

The updated transfer function may therefore provide a recalibrated framework that mitigates the effect of chaff dampening or simulating grain strikes against the shoe loss sensors 62, 64, and thus enhance the precision of grain loss detection. By dynamically adjusting the transfer function in response to real-time residue property information, including, for example, chaffer material composition information, the system 200 can be configured to at least attempt to ensure that subsequent determinations of grain loss are more aligned with the actual operational conditions and material flow, including residue, characteristics. This adjustment process can contribute to optimal performance and reduce the risk of inaccurate grain loss calculations that could lead to inefficient corrective measures.

Additionally, or alternatively, the determination at block 1122 that the one or more predetermined thresholds regarding the residue properties, such as, the composition of the chaffer material, does not satisfy one or more predetermined thresholds can trigger the controller 102 to, at block 1126, implement one or more adjustments or other corrective actions in the operation of the agricultural machine 20, including, for example, with respect to settings of the cleaning shoe 42.

For example, at block 1126, the operation of the fan 44 can be adjusted in a manner that can modify a rate of airflow across the sieve 48 and chaffer 50. More specifically, if the analysis, including, for example, composition analysis, at block 1122 indicates excessive chaff relative to grain, a fan speed of the fan 44 can be increased to enhance the separation process. Such an increase in the speed of the fan 44 can facilitate a blowing of lighter chaff in a generally rearward direction while allowing heavier grain to settle through either or both the chaffer 50 and the sieve 48.

Additionally, or alternatively, at block 1126, a spacing of the louvers 106 on either or both the chaffer 50 and the sieve 48 can be adjusted. For example, if the analysis at block 1120 indicates a high proportion of chaff in the chaffer material, then the size of the openings of either or both the chaffer 50 and the sieve 48 can be reduced in an attempt to reduce the amount of at least chaff that can pass through the associated chaffer 50 or sieve 48.

According to certain embodiments, at block 1126, in response to the residue property, including, for example, chaffer material composition, determination at block 1120, the rotational speed of the rotor 38 in the separator 36 can be modified in a manner that adjusts threshing of the crop material. For example, an increased speed of the rotor 38, also referred to as rotor speed, can be employed if the grain to chaff ratio suggests an incomplete separation of crop from MOG to facilitate a potential improvement in crop separation.

Additionally, at block 1126, the actuation arrangement 52 can adjust the fore and aft angles of either or both the chaffer 50 and sieve 48 to facilitate a change in a trajectory of the material flow in at least an attempt to improve stratification of grain and chaff.

Further, at block 1126, the flow rates of crop material through the tailings system 65 can be adjusted. Such adjustments can include adjusting the speed of the tailings auger 68 in at least an attempt to manage crop material recirculation and thereby correct potential discrepancies in the grain to chaff ratios in the distributed tailings materials.

Such changes at block 1126 can also include changes in the speed of travel of the agricultural machine 20. For example, in situations in which the information determined at block 1120 indicates a relatively high level of grain loss is, or can be, occurring, then at block 1126 the speed of travel of the agricultural machine 20 can automatically be decreased, such as, for example, in response to a signal(s) generated by the controller 102. Alternatively, according to other embodiments, the controller 102 can generate one or more signals to facilitate a visual or audible alert being communicated to the operator of the agricultural machine 20 suggesting a reduction in travel speed. In such instances, such a reduction in the travel speed of the agricultural machine 20 can reduce the rate at which crop material is entering and being processed by the agricultural machine 20, which can assist with improving the separating efficiency attained by the agricultural machine 20, including by the cleaning shoe 42.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A residue detection system for analysis of a chaffer material collected from a flow of a first crop material residue along a chaffer of a cleaning shoe of an agricultural machine, the residue detection system comprising:
a gate selectively displaceable between an open position and a closed position;
an imaging system including an optical device;
a material flow pathway configured to receive at least a second crop material residue;
at least one processor; and
a memory coupled with the at least one processor, the memory including instructions that, when executed by the at least one processor, cause the at least one processor to:
generate, a signal to facilitate a displacement of the gate from the closed position to the open position, the gate, when in the open position, positioned to provide an opening for the chaffer material to be delivered to the material flow pathway;
generate a signal to activate the optical device to obtain a captured information of the chaffer material; and
determine, using at least the captured information, a residue property of the chaffer material.

2. The residue detection system of claim 1, further including a first sensor configured to sense information regarding a characteristic of the second crop residue in the material flow pathway, wherein the memory further includes instructions that, when executed by the at least one processor, cause the at least one processor, in response to sensed information provided by the first sensor, to displace the gate from the closed position to the open position.

3. The residue detection system of claim 1, wherein the gate comprises a plurality of gates, each gate of the plurality of gates being independently displaceable between the open position and the closed position and, when in the open position, positioned to collect a different portion of the first crop material residue for the chaffer material, and
wherein the memory further includes instructions that, when executed by the at least one processor, cause the at least one processor to select, in response to a detection of an operational characteristic, one or more gates of the plurality of gates to displace to the open position.

4. The residue detection system of claim 1, wherein the gate is positioned between the chaffer and an ancillary sieve, the ancillary sieve positioned for at least a portion of first crop material residue to flow through the ancillary sieve and contact one or more shoe loss sensors.

5. The residue detection system of claim 1, wherein the memory further includes instructions that, when executed by the at least one processor, cause the at least one processor to determine whether the captured information obtained by the optical device relates to at least the chaffer material based on a time delay between when the captured information is obtained relative to a time the gate was displaced to the open position.

6. The residue detection system of claim 1, wherein the material flow pathway is located within a grain tailings system, and wherein the second crop material residue does not enter the material flow pathway through the gate.

7. A residue detection system for analysis of a chaffer material collected from a flow of a crop material residue along a chaffer of a cleaning shoe of an agricultural machine, the residue detection system comprising:
a gate selectively displaceable between an open position and a closed position;
a tailings system including a tailings trough, a first sensor, a tailings elevator, and an optical system, the tailing trough configured to receive a grain tailings, the gate positioned, when the gate is in the open position, to provide a passageway for a delivery of the chaffer material to the tailing trough, the tailings elevator configured to convey at least a portion of the chaffer material to a location at which the portion of the chaffer material is within a field of view of an optical device of the optical system;
at least one processor; and
a memory coupled with the at least one processor, the memory including instructions that, when executed by the at least one processor, cause the at least one processor to:
generate a signal to activate the optical device to capture a captured information of at least the portion of the chaffer material that is within the field of view of the optical device; and
determine, using at least the captured information, a residue property of at least the portion of the chaffer material.

8. The residue detection system of claim 7, wherein the memory further includes instructions that, when executed by the at least one processor, cause the at least one processor, in response to a detection of a trigger event, to displace the gate from one of the close position and the open position to the other of the closed position or the open position.

9. The residue detection system of claim 8, wherein the trigger event is an expiration of a predetermined time period, and wherein the grain tailings do not enter the tailings trough through the gate.

10. The residue detection system of claim 8, wherein the tailings system includes a sensor, and wherein the trigger event is a determination by the at least one processor based at least in part on sensed information from the sensor that an amount or a flow rate of either or both grain tailings or the chaffer material within the tailings trough satisfies a predetermined threshold.

11. The residue detection system of claim 7, wherein the memory further includes instructions that, when executed by the at least one processor, cause the at least one processor to determine whether the captured information depicts, at least in part, the portion of the chaffer material based on a time delay between when the gate is in the open position and when the captured information is or was obtained.

12. The residue detection system of claim 7, wherein the memory further includes instructions that, when executed by the at least one processor, cause the at least one processor to determine whether the captured information depicts, at least in part, the chaffer material based on an amount of a material in the captured information.

13. The residue detection system of claim 7, wherein the residue property comprises an amount of grain or a grain to chaff ratio.

14. The residue detection system of claim 7, wherein the gate comprises a plurality of gates, each gate of the plurality of gates being independently displaceable between the open position and the closed position and, when in the open position, positioned to receive a different portion of the crop material residue as the chaffer material, and
wherein the memory further includes instructions that, when executed by the at least one processor, cause the at least one processor to select, in response to a detection of an operational characteristic, one or more gates of the plurality of gates to displace to the open position.

15. A method for analyzing a chaffer material collected from a flow of a first crop material residue along a chaffer of a cleaning shoe of an agricultural machine, the method comprising:
displacing a gate from a closed position to an open position;
delivering, in response to the gate being displaced to the open position, the chaffer material through the gate and into a material flow pathway;
capturing, by the optical device as a captured information, the chaffer material that is within the field of view; and
determining, from the captured information, a residue property of the chaffer material.

16. The method of claim 15, wherein the material flow pathway comprises a second crop residue material that was not delivered to the trough through the gate.

17. The method of claim 16, further comprising:
determining, prior to displacing the gate to the open position, a steady state information for the second crop residue material in the material flow pathway; and
determining, using at least the steady state information, whether to displace the gate to the open position to introduce the chaffer material into the material flow pathway.

18. The method of claim 16, wherein capturing the captured information further comprises displacing the chaffer material along an elevator to a position at which the chaffer material is within the field of view of the optical device.

19. The method of claim 16, further comprising determining whether the captured information depicts at least the chaffer material based on at least one of a time between the displacing of the gate to the open position and the capturing of the captured information or a change in an amount of either or both the chaffer material or the second crop residue material displaced to be within the field of view.

20. The method of claim 17, further comprising adjusting a transfer function configured to determine grain loss from the agricultural machine based at least in part on the result of the determination of the residue property of the chaffer material.
